(19) United States
(12) Patent Application Publication
(10) Pub. No.: US 2008/0153052 A1
(43) Pub. Date: Jun. 26, 2008

(54) LIGATURE DEVICE FOR ORTHODONTIC BRACKETS

(76) Inventors: John A. Ianieri, Moorestown, NJ (US); Nancy J. Ianieri, Moorestown, NJ (US); Nelson R. Krupp, Abington, PA (US)

Correspondence Address: Connolly Bove Lodge & Hutz LLP, P.O. Box 2207, Wilmington, DE, 19899-2207, US

(21) Appl. No.: 11/613,220

(22) Filed: Dec. 20, 2006

(51) Int. Cl. A61C 7/18

(52) U.S. Cl. 433/11

(57) ABSTRACT

A ligature device for orthodontic brackets comprises an elastic body in the form of two rings integrally connected at their periphery to form a figure eight. The body is stretchable so that each of the rings could be stretched and looped around opposite wings of an orthodontic bracket to trap an archwire in the bracket. The body is in the shape of the figure eight when the body is in its initial unstressed condition with the rings coplanar with each other.

### BACKGROUND OF THE INVENTION

In current practice an archwire shaped in the curve desired for the patient's dental arch is placed into slots of the brackets (braces) on the teeth and held there (ligated) with similar circular loops of a rubber-like elastomer. Normally the ligature is drawn around the hook-shaped “wings” of a bracket and over the archwire pulling the archwire into its slot, thus applying forces on the tooth to conform to the shape of the spring-like metal archwire. The ligature follows roughly a circular pathway around the bracket and over the archwire, without crossing over upon itself. The practitioner may in some cases deviate from this protocol where extra forces are required.

This altered protocol is used where protraction or translation of a tooth in the labial or occlusal direction of a given tooth is required in the orthodontic treatment schedule. The ligature is gripped with a plier and crossed over as it is pulled over the archwire. The practitioner currently ligates the gingival “wings” of the bracket on a given tooth, then pulls it in the occlusal direction and rotates the plier 180 degrees and then ligates the occlusal “wings” of the same bracket. The difficulty arises when ligating the third and fourth “wings”. When this loop is twisted and drawn over the archwire it becomes difficult to place it on the “wings” since there is now no opening for the wing to go through. The practitioner must “fiddle” with it or use a second instrument, an orthodontic “explorer”, to open the hole to finish ligating the third and fourth wings.

Other examples of ligature devices are shown in U.S. Pat. No. 5,540,586 and U.S. Published patent application 2005/0266369.

### SUMMARY OF THE INVENTION

An object of this invention is to provide a ligature device for orthodontic brackets which is low in cost and simple to use.

In accordance with this invention the ligature device comprises an elastic body with two rings connected in the middle forming the number or figure eight. As a result, each ring could be stretched over a pair of wings on one side of the archwire without requiring any twisting of the rings.

### THE DRAWINGS

FIG. 1 is a top plan view of a ligature device for orthodontic brackets in accordance with this invention;

FIG. 2 is a front elevational view of the ligature device shown in FIG. 1;

FIG. 3 is a side elevational view of the ligature device shown in FIGS. 1-2; and

FIG. 4 is a perspective view showing the ligature device of FIGS. 1-3 mounted on an orthodontic bracket.

### DETAILED DESCRIPTION

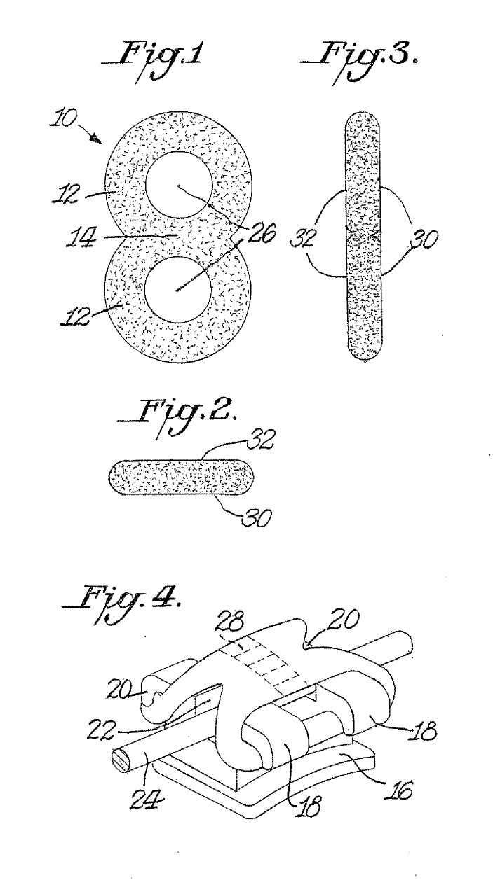

FIGS. 1-3 illustrate a ligature device 10 in the unstretched condition in accordance with this invention. As shown therein the ligature device 10 comprises an elastic body which would be made of an elastic or stretchable resilient material conventionally used as ligature devices. Device 10, however, is distinctive in that the elastic body comprises two rings 12,12 which are connected together in the middle or junction area 14 so as to form a one piece integral body forming the number or figure eight wherein the junction area 14 is common to both rings. As later described this form of ligature device simplifies the application of an elastomeric ligation to an orthodontic bracket into the desired figure eight fashion with much greater ease than with conventional protocols.

The ligature device 10 enables the practitioner to ligate in a figure eight fashion with only one tool and less frustration. FIG. 4, for example, shows the device 10 mounted in place. As shown therein, an orthodontic bracket 16 could be of any conventional construction and would include two sets of wings 18,18 and 20,20. Two sets of wings are separated by an elongated slot 22 in which the archwire 24 would be placed. The practitioner is able to ligate in a figure eight fashion the ligature device 10 with only one tool and with less frustration. The ligature device 10 would be gripped with a plier. One hole 26 of device 10 would be looped around one set of the two wings, such as wings 18,18 on one side of the archwire 24 and then the device 10 would be drawn across the archwire with the other hole 26 being used for the third and fourth wings 20,20. The problems associated with twisting would be eliminated resulting in a faster application with less frustration.

Since friction is a concern for many practitioners the figure eight application achieves an extreme decrease in the friction between the bracket/ligature and the archwire since the figure eight application causes the ligature to be put with very little pressure on the archwire when it is seated in the archwire slot.

The invention could be practiced where the ligature devices are provided in sets with the individual ligature devices of the sets being in differing colors allowing the patient a choice to achieve his/her fashion statement. For example, the entire ligature device could be of one color as compared to other ligature devices in the set and/or portions of the ligature device could include various indicia including colors to distinguish one device from another. Such indicia could be team colors, favored colors, colors of national flags, logos, etc. FIG. 4 illustrates in block form various logos 28 in the junction area 14 of the ligature device body. Thus, the ligature device 10 has the secondary benefit of having more surface area visible from outside the mouth. This increased surface area lends itself to the use of various forms of indicia including different colors for the individual ligature devices.

In the preferred form of this invention when device 10 is in its unstretched condition, each ring 12,12 has a peripheral arc of constant radius. See FIG. 1. In that regard, each ring comprises a circular segment formed by a continuous arc. It is to be understood, however, that the invention could be broadly practiced where, instead of circular segment rings, the rings could be of elliptical shape.

As shown in FIG. 1 in the preferred practice of this invention the continuation of each arc of the circular segment ring 12 would be tangent to the circular open area 26 of the other ring.

In the preferred practice of this invention the open area 26 of each ring 12 is also of circular shape. The invention, however, could be practiced with some other shape of open area. What is important is that the open area be of sufficient size to facilitate looping each ring around its set of wings of the orthodontic bracket.

As is apparent from FIGS. 2-3 each ring has a first outer surface 30 and a second opposite outer surface 32. The outer surfaces of both rings are coplanar with each other. As is also apparent from FIGS. 1-3 when the ligature device 10 is in its initial unstressed condition the body is in the figure eight shape with the rings 12,12 coplanar with each other. The actual rings may be somewhat similar to donuts having curved outer edges and curved inner edges and the outer surfaces 30,32 might also be curved but the curvatures of each ring would be coplanar with the curvatures of its adjacent connected ring.

Although not illustrated, a plurality of individual ligature devices 10 could be packaged by being attached tangentially to a common carrier strip so that each device 10 could simply be snipped or pulled out of engagement with the carrier strip when it is desired to use the device 10. A single carrier strip could have a plurality of devices 10 which progressively increase/decrease in size.

What is claimed is:

1. A ligature device for orthodontic brackets comprising a one piece elastic body in the form of two rings integrally connected at their periphery to form a figure eight, said rings having a common junction area, said body being stretchable to permit each of said rings to be stretched and looped around opposite wings of an orthodontic bracket to trap an archwire in the bracket, and said body being in the shape of said figure eight when said body is in its initial unstressed condition with said rings co-planar with each other.

2. The device of claim 1 wherein each of said rings has a peripheral arc of constant radius.

3. The device of claim 2 wherein each of said rings has a central open area, and the continuation of each arc for each of said rings being tangent to said open area of the other of said rings.

4. The device of claim 2 wherein said body includes indicia on its exposed outer surface.

5. The device of claim 4 in combination with a plurality of said devices to form a set having different indicia of different devices of said set.

6. The device of claim 5 wherein said different indicia comprises different colors.

7. The device of claim 4 wherein said indicia is located at said junction area.

8. The device of claim 4 wherein said open area is of circular shape.

9. The device of claim 1 wherein each of said rings comprises a circular segment formed by a continuous arc.

10. The device of claim 1 wherein each of said rings has a first outer surface and an opposite second outer surface, said first outer surfaces being co-planar with each other, and said second outer surfaces being co-planar with each other.

11. The device of claim 1 in combination with an orthodontic bracket and an archwire, said orthodontic bracket having two sets of wings separated by a slot, said archwire being in said slot, and each of said rings being stretched over an mounted to a respective set of said wings in an untwisted condition.
